(19) United States
(12) Patent Application Publication
(10) Pub. No.: US 2014/0177843 A1
(43) Pub. Date: Jun. 26, 2014

(54) METHOD AND SYSTEM FOR REDUCING AMPLITUDE MODULATION (AM) NOISE IN AM BROADCAST SIGNALS

(71) Applicant: Yao H. Kuo, West Bloomfield (US)

(72) Inventor: Yao H. Kuo, West Bloomfield (US)

(73) Assignee: VISTEON GLOBAL TECHNOLOGIES, INC, Van Buren Township, MI (US)

(21) Appl. No.: 13/721,396

(22) Filed: Dec. 20, 2012

(51) Int. Cl. H04H 20/88

(52) U.S. Cl. CPC H04H 20/88
USPC 381/15

(57) ABSTRACT

A computer-implemented method for reducing a noise signal added to an amplitude modulated (AM) broadcast signal while travelling from a broadcasting antenna to a receiving antenna is provided. The method includes capturing a signal representative of the AM broadcast signal corrupted by the noise signal via the receiving antenna, inverting the captured signal, and determining a carrying frequency of the AM broadcast signal and delaying the inverted waveform by a fraction of a cycle of the carrying frequency. The method further includes generating a difference signal by subtractively combining the captured signal and the delayed inverted signal, generating an estimate noise signal by reducing an amplitude of the generated difference signal using a noise-reduction control multiplier, and minimizing the corrupting noise signal component of the captured signal by subtractively combining the captured signal and the generated estimate noise signal.

### BACKGROUND

Unless otherwise indicated herein, the materials described in this section are not prior art to the claims in this application and are not admitted to be prior art by inclusion in this section.

Amplitude modulation (AM) broadcasting is a process of radio broadcasting that was the first method of impressing sound on a radio signal and is still widely used today. As known to one ordinary skill in the art, AM broadcasting signal has low immunity from interfering signals. As shown in FIG. 1, during an AM signal travel from a broadcasting antenna tower 102 to an AM receiver antenna 104 coupled to an AM broadcast receiving device or apparatus 106, many possible noise signals may become add-on or interference signals to the original AM signal. These interference noise signals can be generated by a number of sources, such as power-line noise, lightning, other wireless communications, etc. . . . . These interference noise signals are captured together with the AM broadcast signal by the receiver circuit to become an in-band noise.

In the case, for example, when AM broadcast receiving apparatus 106 is installed in a car, electrical motor noise and electromagnetic interferences generated by the car's electrical circuits/devices may increase the noise interference to the original AM broadcast signal.

Therefore, there is a need for a system and method that can help minimize AM broadcast interferences caused by noise signals.

### SUMMARY

Disclosed herein are improved a method and system for reducing AM noise in AM broadcast signals.

In one aspect, a computer-implemented method for reducing a noise signal added to an amplitude modulated (AM) broadcast signal while travelling from a broadcasting antenna to a receiving antenna is provided. The method includes capturing a signal representative of the AM broadcast signal corrupted by the noise signal via the receiving antenna, inverting the captured signal, and determining a carrying frequency of the AM broadcast signal and delaying the inverted waveform by a fraction of a cycle of the carrying frequency. The method further includes generating a difference signal by subtractively combining the captured signal and the delayed inverted signal, generating an estimate noise signal by reducing an amplitude of the generated difference signal using a noise-reduction control multiplier, and minimizing the corrupting noise signal component of the captured signal by subtractively combining the captured signal and the generated estimate noise signal.

In another aspect, the computer-implemented method further includes filtering captured signal prior to the signal inversion.

In another aspect, the computer-implemented method further includes processing the captured signal through a low noise amplifying unit.

In another aspect, the computer-implemented method further includes processing the captured signal through an analog to digital converting unit to generate a digital version of the captured signal prior to the signal inversion.

In another aspect, the noise-reduction control multiplier is equal to a rational number 1/n with n being a number that is greater than a first value equal to about one (1) and is less than a second value equal to about two (2).

In another aspect, a computer readable storage medium having stored therein instructions executable by a computing element to cause the computing element to perform the above-introduced method.

These as well as other aspects, advantages, and alternatives will become apparent to those of ordinary skill in the art by reading the following detailed description, with reference where appropriate to the accompanying drawings. Further, it should be understood that the disclosure provided in this summary section and elsewhere in this document is intended to discuss the embodiments by way of example only and not by way of limitation.

### BRIEF DESCRIPTION OF THE FIGURES

In the figures:

FIG. 1 is a schematic diagram illustrating an embodiment of an AM broadcast signal corrupted by a number of interfering signals and captured by a receiver antenna;

FIGS. 2A-B are two graphs illustrating an uncorrupted AM broadcast signal and one of its period that has been inverted and delayed by a half-cycle;

FIG. 3 is a graph illustrating an AM broadcast signal with a predetermined amplitude modulation on a signal carrier;

FIG. 4 is a graph illustrating a zoomed section of the AM broadcast signal of FIG. 3;

FIG. 5 is a graph illustrating a near-symmetrical characteristics of an upper half-cycle and of an inverted lower half-cycle of a waveform cycle of the zoomed signal section of FIG. 4;

FIG. 6 is a block diagram illustrating an exemplary embodiment of a system, that includes an analog signal processing unit, for reducing AM noise captured by an AM receiver;

FIG. 7 is a flow chart illustrating an example embodiment of a method for reducing AM noise using the analog signal processing unit of FIG. 6;

FIG. 8 is a block diagram illustrating an exemplary embodiment of a system, that includes a digital signal processing unit, for reducing an in-band AM noise signal captured by an AM receiver;

FIG. 9 is a flow chart illustrating an example embodiment of a method for reducing AM noise using the digital signal processing unit of FIG. 8;

FIG. 10 is a block diagram illustrating another exemplary embodiment of a system, that includes another digital signal processing unit, for reducing an in-band AM noise signal captured by an AM receiver;

FIG. 11A-C are three graphs that illustrate a corrupted AM broadcast signal, and a demodulated noise signal that corrupted the AM broadcast signal;

FIGS. 12A-C are three graphs that illustrate the corrupted AM broadcast signal of FIG. 4A after a reduction of the demodulated noise signal of FIG. 4C, which has been achieved with a value of an adaptive control factor selected by one of the corresponding systems shown in FIGS. 2 and 3;

FIGS. 13A-C are three graphs that illustrate the corrupted AM broadcast signal of FIG. 4A after another reduction of the demodulated noise signal of FIG. 4C, which has been achieved with another value of the adaptive control factor selected by one of the corresponding systems shown in FIGS. 2 and 3;

FIG. 14 is a graph illustrating an embodiment of another uncorrupted AM broadcast signal;

FIG. 15 is a graph illustrating the AM broadcast signal of FIG. 14 as corrupted by a couple of interfering signals;

FIG. 16 is a graph illustrating a composite of the signals interfering the AM broadcast signal of FIG. 15;

FIG. 17 is a graph illustrating an embodiment of an AM broadcast signal output by one of systems of FIGS. 6, 8, and 10 after reduction of the interfering signals of FIG. 16;

FIG. 18 is a graph illustrating an embodiment of an AM broadcast signal output by one of systems of FIGS. 6, 8, and 10 after reduction of the interfering signals of FIG. 16; and

FIG. 19 is a schematic drawing illustrating a computing network system according to an exemplary embodiment.

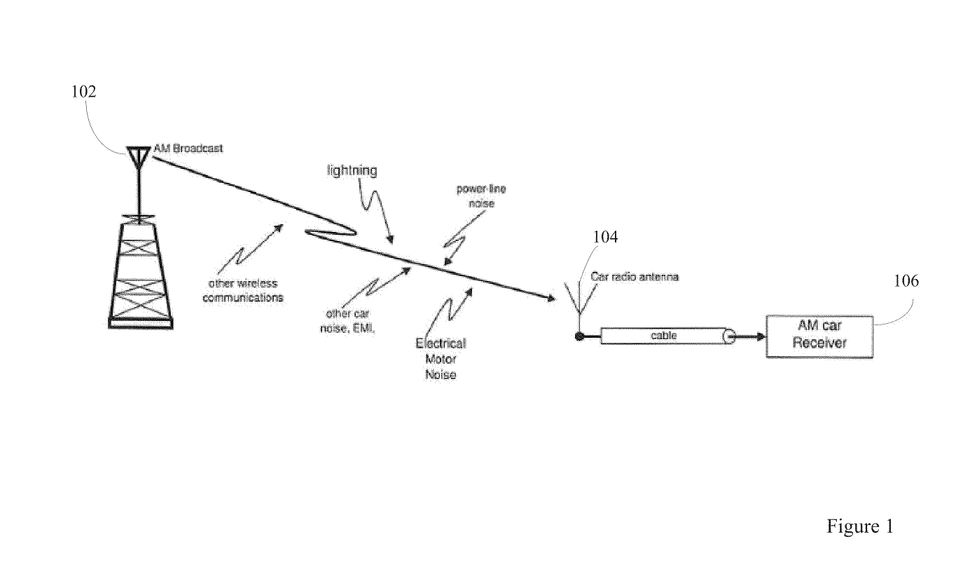

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### Overview

Some conventional noise suppression systems are known to use a noise generator coupled to a noise canceller. One such noise suppression system may include a tuner configured to selectively receive a radio wave signal and to transform it into an electric signal, a field information detector to detect electric field information of the radio wave signal received by the tuner, a noise data generator that generate a noise pattern on the basis of the detected electric field information, a noise canceler configured to remove a noise component from the signal outputted from the tuner on the basis of the noise pattern generated by the noise data generator. However, these noise data generators are known to lack the accuracy to generate a noise signal that can be considered a substantial reproduction of the captured noise signal.

Accordingly, an embodiment of the proposed noise reducing method is configured to process and analyze “near-symmetric” characteristics of a received AM broadcast signal. As such, the proposed method is configured to produce noise signals that are substantially similar to the original add-on noise signals. The reproduced noise signals are then used to cancel substantially all or at least the majority of the add-on noise signals before the AM de-modulation process of the received AM broadcast signal.

As known to one of ordinary skill in the art, in telecommunications, a carrier wave or carrier is a waveform (usually sinusoidal) that is modulated (modified) with an input signal for the purpose of conveying information. This carrier wave is usually a much higher frequency than the input signal. The purpose of the carrier is usually either to transmit the information through space as an electromagnetic wave (as in radio communication), or to allow several carriers at different frequencies to share a common physical transmission medium by frequency division multiplexing (as, for example, a cable television system).

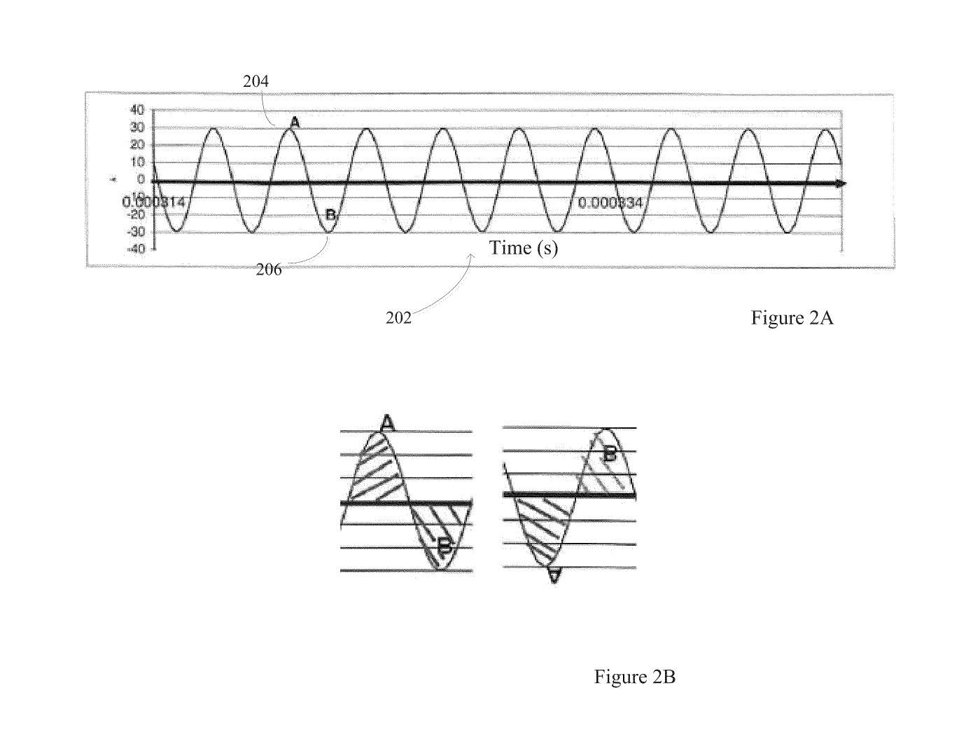

Now referring to FIG. 2A, an exemplary embodiment 200 of a perfect sinusoidal waveform 202 is illustrated. As an example, waveform 202 represents un-modulated AM carrier waveform at 300 KHz without interference. As shown, waveform 202 is a smooth repetitive oscillating waveform with a periodically constant amplitude, i.e., peak deviation from zero. As shown in FIG. 2A, waveform 202 includes a positive peak A 204 and a negative peak B 206. Because waveform 202 is a perfect sine wave, if a half cycle delay is applied to the waveform 202 then, as shown in FIG. 2B, peak A becomes peak B and peak B becomes peak A, i.e., A=−B. That is, waveform 202 at peak A is the same as at inverted peak B with a half carrier cycle delay. Accordingly, peak A and peak B are considered to be symmetrical with respect to waveform 202.

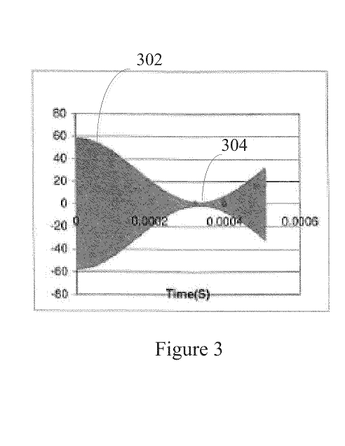

Now referring to FIG. 3, an exemplary embodiment 300 of an AM broadcast signal waveform 302 with a predetermined amplitude modulation on a signal carrier waveform (not shown) is illustrated. As an example, AM broadcast waveform 302 has a frequency of 1.5 KHz and a 95% amplitude-modulation on the waveform carrier with a 300 KHz frequency.

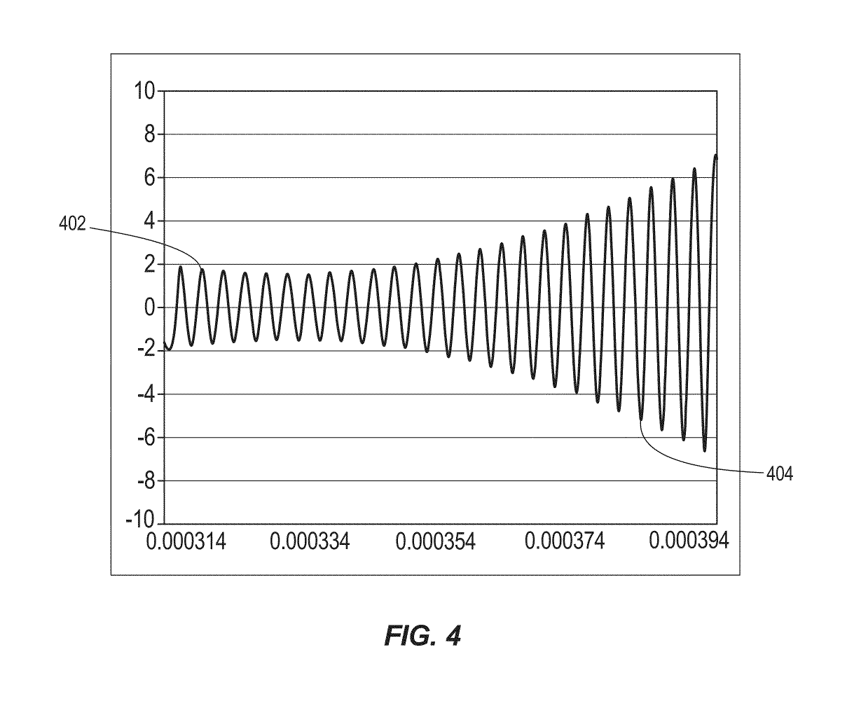

Now referring to FIG. 4, a waveform 402 representing a zoomed-in section 304 of the waveform carrier of FIG. 3 is shown. Zoomed-in section 304 corresponds to a waveform section associated with time points T1 and T2, which are close to about 3×10⁻⁴ seconds and about 4×10⁻⁴ seconds, respectively.

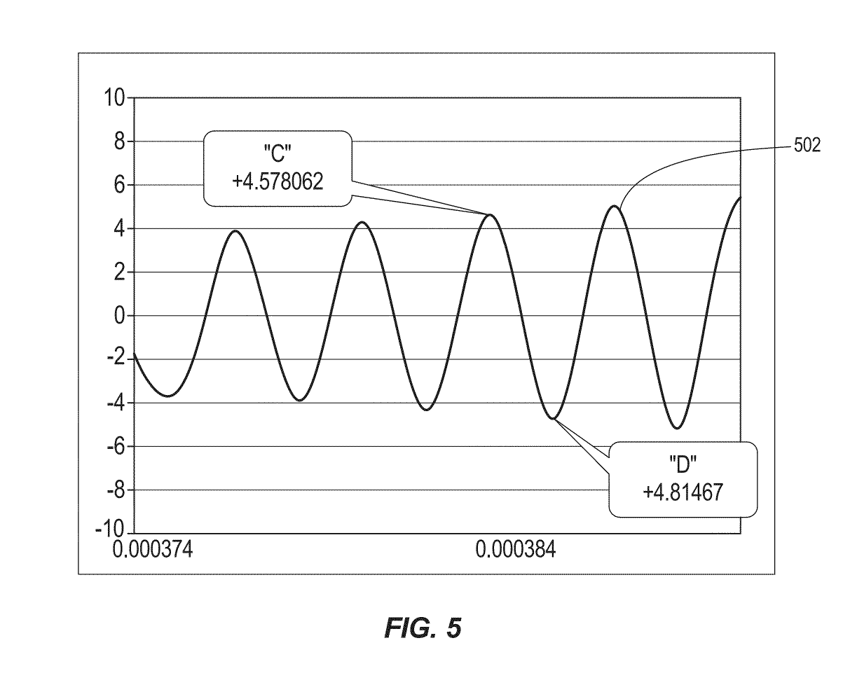

Now referring to FIG. 5, a waveform 502 representing a zoomed-in section 404 of waveform 402 of FIG. 4 is shown. The zoomed section corresponds to a waveform section associated with time points T3 and T4, which are equal to about 374×10⁻⁶ seconds and about 390×10⁻⁴ seconds, respectively. As shown in FIG. 5, waveform 502 includes an upper cycle peak “C” that has a magnitude equal to +4.578062, and an adjacent lower cycle peak “D” that has a magnitude equal to −4.81467. As such, upper cycle peak “C” is close to but not exactly the same as “inverted lower cycle peak “D.” Thus, waveform 502 is a “Near Symmetrical” waveform. As known to one of ordinary skill in the art, a lower modulation index (%) leads to a more symmetrical waveform. Further, a higher audio and carrier frequency ratio leads to a more symmetrical waveform. Also, a lower modulation frequency leads to a more symmetrical waveform.

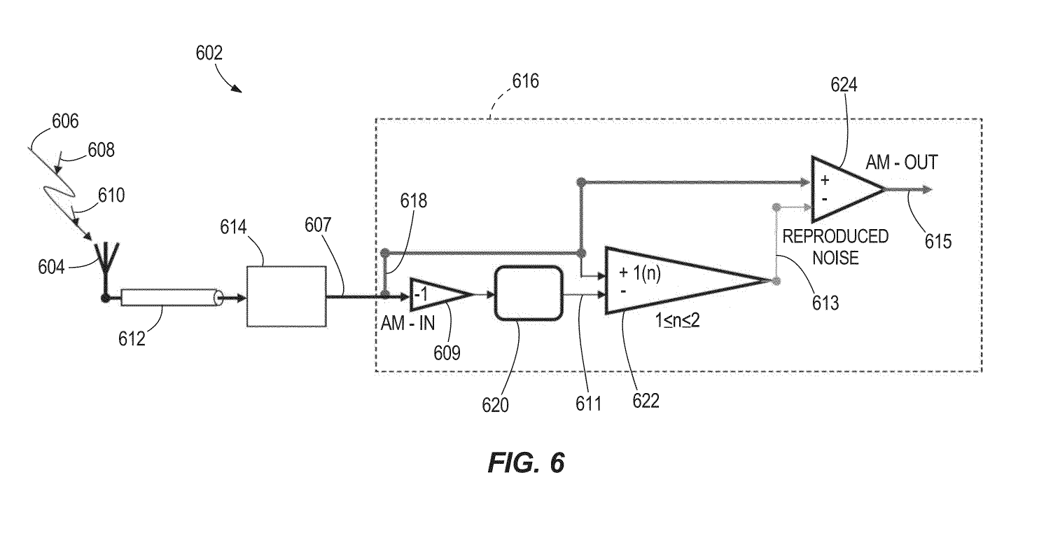

Now referring to FIG. 6, a schematic diagram 600 illustrates an exemplary embodiment of an analog system 602 for reducing noise signals added to an AM broadcast signal. As shown, system 602 includes an antenna 604 for capturing an AM broadcast signal 606 augmented with add-on noise signals 608 and 610. Captured AM broadcast signal 606 is a signal based on airwaves transmitted from a broadcasting station (not shown). System 602 further includes a cable unit 612 for communicating AM broadcast signal 606 to a filter and low-noise amplifier combination unit 614, hereafter referred to as F&LNA unit 614, and an analog signal processing unit 616 for AM noise reduction. In one embodiment, the filter of F&LNA unit 614 can be a two pole bandpass filter. As shown in FIG. 6, analog signal processing unit 616, hereafter referred to as analog AM noise reducing unit, includes a signal inverting unit 618, a signal delaying unit 620, a signal subtracting and reducing unit 622, and a signal subtracting unit 624.

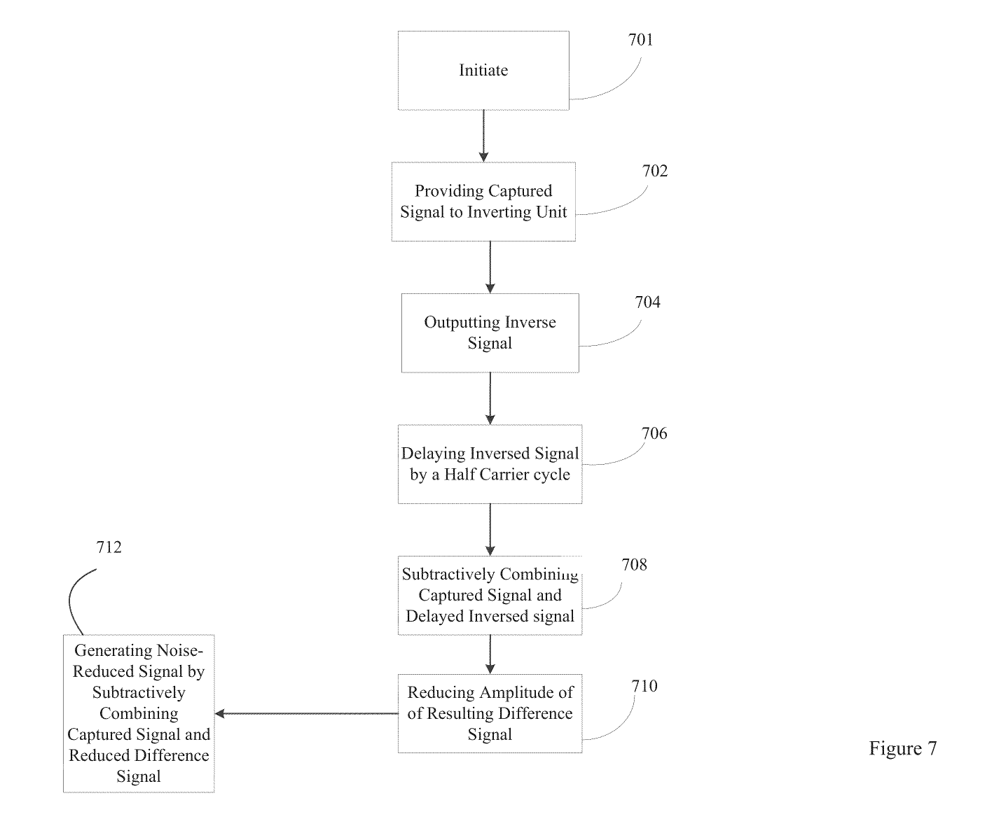

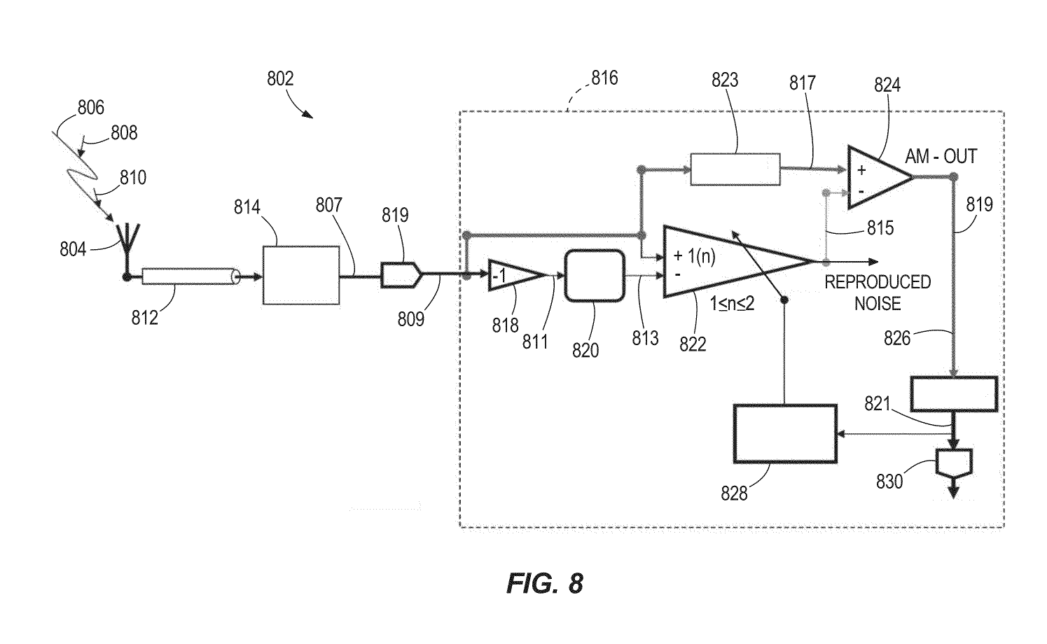

Now referring to FIG. 7, a flow chart 700 illustrates an example embodiment of a method for reducing/minimizing add-on noises using analog AM noise reducing unit 616. During operation, upon initiation of the method at step 701, F&LNA unit 614 processes AM broadcast signal 606 to output AM signal 607. At step 702, AM noise reducing unit 616 is configured to provide AM signal 607 to signal inverting unit 618. Upon receipt of AM signal 607, signal inverting unit 618 processes it to output inverse AM signal 609, at step 704. Then at step 706, AM noise reducing unit 616 provides AM signal 609 to signal delaying unit 620 that is configured to delay AM signal 609 by about a half carrier cycle and to output resulting AM signal 611. Subsequently, AM noise reducing unit 616 provides both AM signal 607 and AM signal 611 to signal subtracting and reducing unit 622, which proceeds to subtractively combine them, at step 708, and to change an amplitude of the resulting difference signal by multiplying it with a rational number that is less than or equal to one (1), at step 710. This rational number can be selected to be equal to about 1/n where n satisfies the following inequality: 1≦n≦2. In accordance with one embodiment, the reduced difference signal 613 represents a generated or re-produced noise signal that is substantially similar to combined add-on noise signals 608 and 610. Then, at step 712, AM noise reducing unit 616 provides both AM signal 607 and reduced difference signal 613 to signal subtracting unit 624, which is configured to subtractively combine them and output an AM noise-reduced signal 615, which is desirably substantially similar to AM broadcast signal 606.

Based on experimental results, AM noise reducing unit 616 substantially reduces add-on noise signals 608 and 610 when n is close to 2. Moreover, an optimal control value of n can be determined adaptively by this noise reduction approach during an on-going processing of AM broadcast signal 606. This optimal control value of n represents a value that best minimizes add-on noise signals 608 and 610.

Now referring to FIG. 8, a schematic diagram 800 illustrates an exemplary embodiment of a digital system 802 for reducing noise signals added to an AM broadcast signal. As shown, system 802 includes an antenna 804 for capturing an AM broadcast signal 806 augmented with add-on noise signals 808 and 810. System 802 further includes a cable unit 812 for communicating captured AM broadcast signal 806 to a filter and low-noise amplifier combination unit 814, hereafter referred to as F&LNA unit 814, an analog to digital (A/D) signal converting unit 819, and a digital signal processing unit 816 for AM noise reduction. As discussed above, the filter of F&LNA unit 814 can be a two pole bandpass filter. As shown in FIG. 8, analog signal processing unit 816, hereafter referred to as digital AM noise reducing unit, includes a signal inverting unit 818, a signal delaying unit 820, a signal subtracting and reducing unit 822, a delay compensation unit 823, a signal subtracting unit 824, an AM de-modulating unit 826, an error control calibration unit 828, and a digital to analog (D/A) converting unit 830.

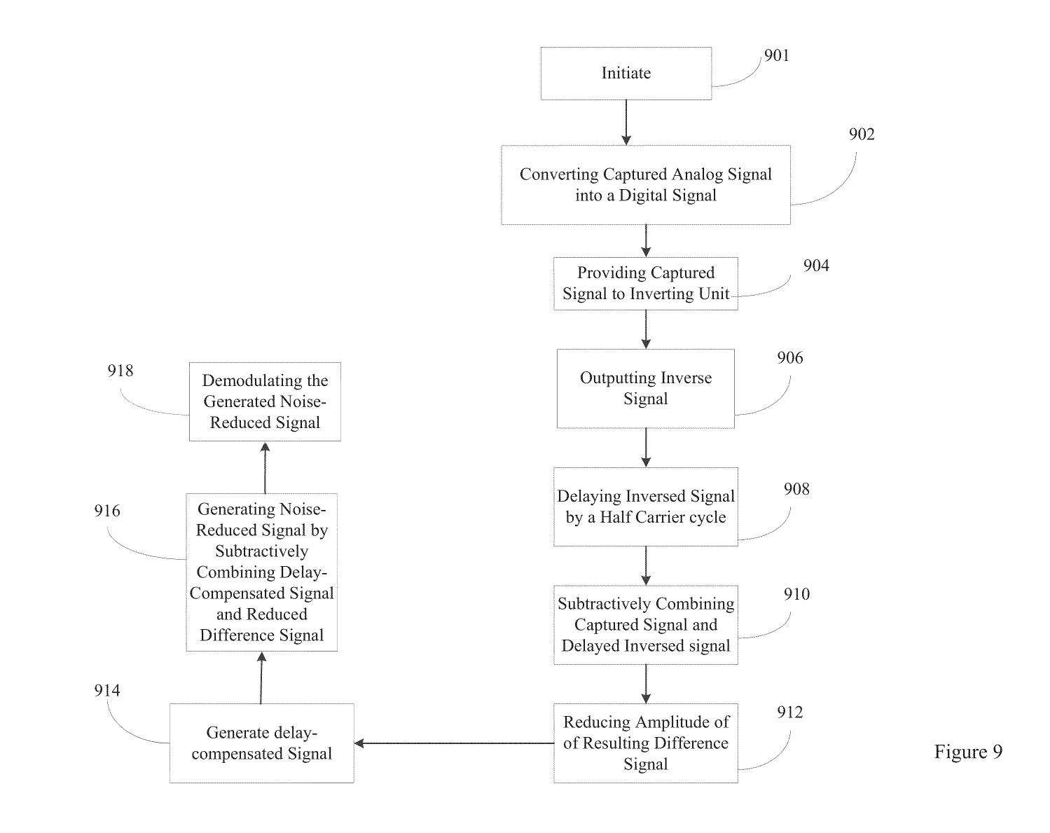

Now referring to FIG. 9, a flow chart 900 illustrates an example embodiment of a method for reducing/minimizing add-on noises using digital AM noise reducing unit 816. During operation, upon initiation of the method at step 901, F&LNA unit 814 processes AM broadcast signal 806 to output AM signal 807. At step 902, A/D signal converting unit 819 is configured to convert AM signal 807 to a digital signal 809. AM noise reducing unit 816 is configured to provide AM digital signal 809 to signal inverting unit 818, at step 904. Upon receipt of AM digital signal 809, signal inverting unit 818 processes it to output inverse AM digital signal 811, at step 906. Then, AM noise reducing unit 816 provides AM digital signal 811 to signal delaying unit 820 that is configured to delay AM digital signal 811 by about a half carrier cycle and to output resulting AM signal 813, at step 908. Subsequently, AM noise reducing unit 816 provides both AM signal 807 and AM signal 813 to signal subtracting and reducing unit 822, which proceeds to subtractively combine them, at step 910, and to change an amplitude of the resulting difference signal by multiplying it with a rational number that is less than or equal to one (1), at step 912. As discussed above, alternatively, the rational number can be selected to be equal to 1/n where n satisfies the following inequality: 1≦n≦2. In accordance with one embodiment, the reduced difference signal 815 represents a re-produced noise signal that is desirably substantially similar to combined add-on noise signals 808 and 810. Then, at step 914, AM noise reducing unit 816 provides AM signal 809 to delay compensation unit 823, which is configured to apply a compensating time delay to AM signal 809, and output AM delay-compensated signal 817. Subsequently, at step 916, AM noise reducing unit 816 is configured to provide both AM delay-compensated signal 817 and reduced difference signal 815 to signal subtracting unit 824, which is configured to subtractively combine them and output an AM noise-reduced signal 819, which is substantially similar to AM broadcast signal 806. Further, at step 918, AM noise-reduced signal 819 is demodulated by AM demodulating unit 826, and the resulting demodulated signal 821 is provided to D/A converting unit 830 that converts it into an analog waveform prior to being outputted as an audio signal by a receiving speaker (not shown).

During this noise-reducing process, error control and calibration unit 828 is recruited to analyze demodulated signal 819 and use results of the analysis to adjust as needed the rational number 1/n that is used by signal subtracting and reducing unit 822 in order to improve on the minimization of add-on noise signals 808 and 810.

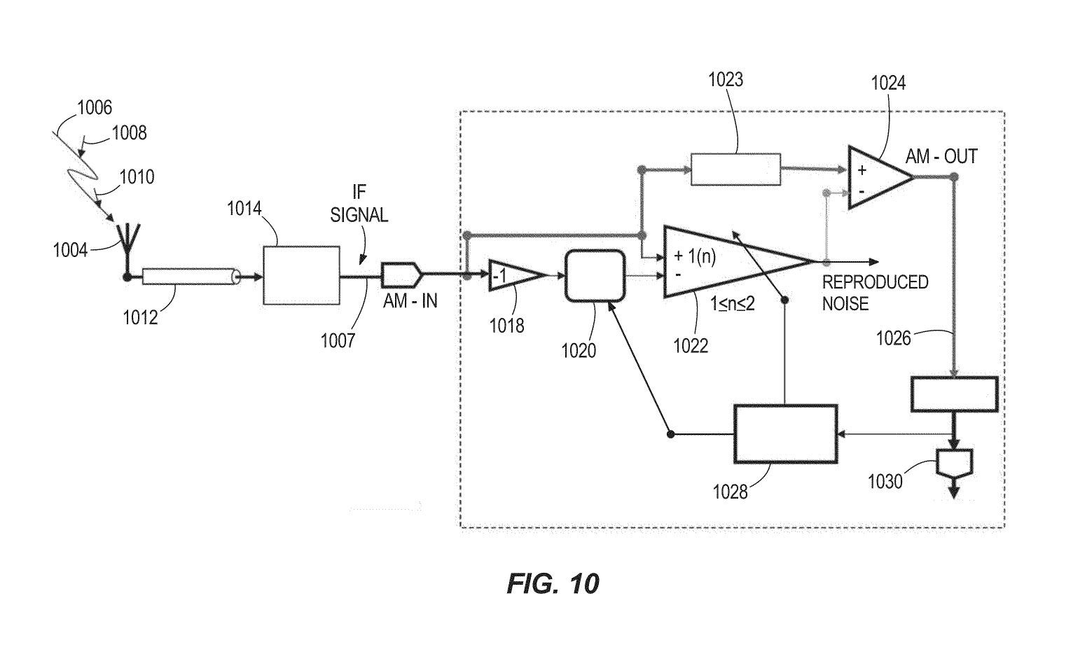

Now referring to FIG. 10, a schematic diagram 800 illustrates another exemplary embodiment of a digital system 1002 for reducing noise signals added to an AM broadcast signal. Digital system 1002 has substantially similar components as those of digital system 802, except that F&LNA unit 1014 further includes a radio processing unit and error control and calibration unit 1028 is further coupled to signal delaying unit 1020. In this configuration of Digital system 1002, F&LNA unit 1014 is configured to identity an intermediate frequency (IF) of AM broadcast signal 1006, to extract from it a signal, denoted IF signal 1007 having the identified intermediate frequency as its main frequency. In one embodiment, the coupling of error control and calibration unit 1028 to signal delaying unit 1020 serves to control the signal delaying process to further improve on the noise reduction process. That is, based on input received from error control and calibration unit 1028, signal delaying unit 1020 adaptively adjusts an amount of signal delay that can be different from a half carrier cycle delay and still leads to a better minimization of add-on noise signals 808 and 810.

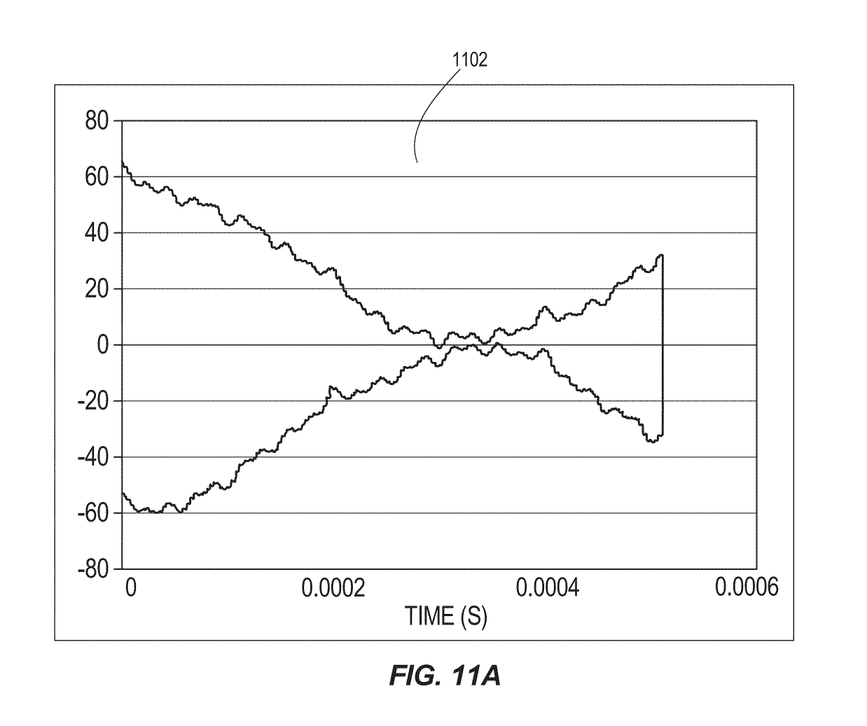

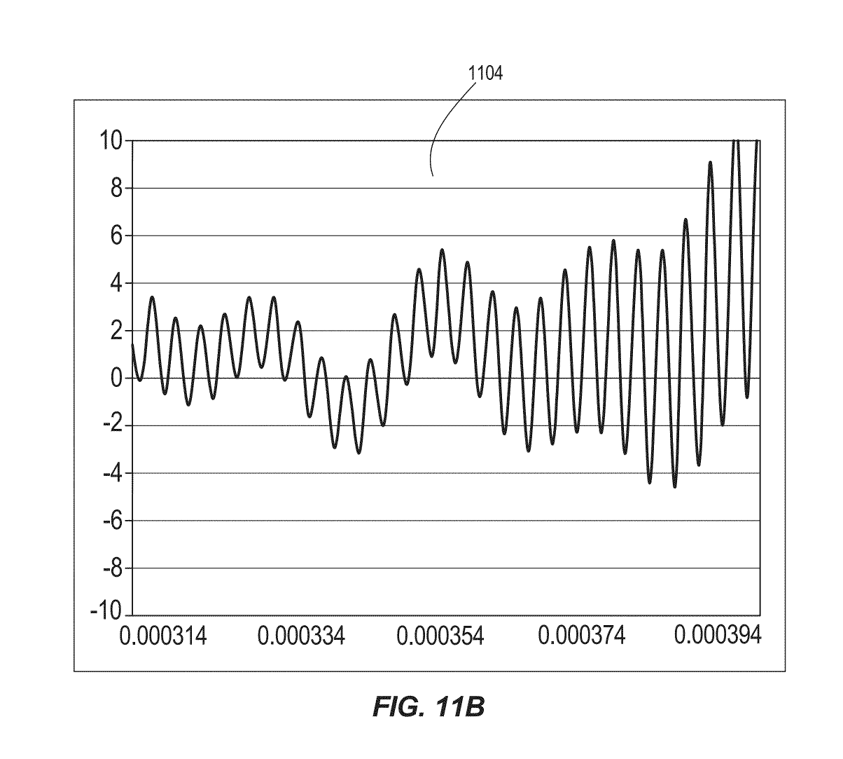

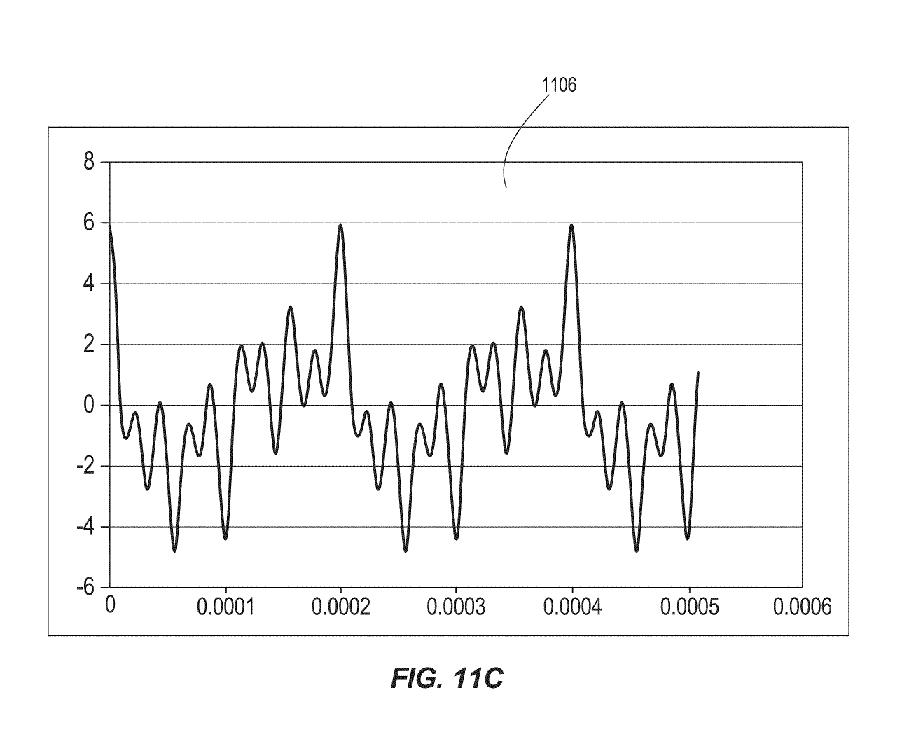

Now referring to FIGS. 11A-C, three graphs are shown that illustrate a corrupted AM broadcast signal 1102, a zoomed section 1104 of AM broadcast signal 1102, and an add-on noise signal 1106 that corrupted AM broadcast signal 1102. FIG. 11A illustrates AM broadcast signal 1102 that was selected to represent AM broadcast signal waveform 302 of FIG. 3 corrupted with add-on noise signals. A zoomed section of AM broadcast signal 1102 is illustrated in FIG. 11B. Subsequent to processing AM broadcast signal 1102 using any one of noise reducing systems 602, 802, and 1002, the add-noise signal 1106 corresponding to the zoomed 1104 section is substantially determined.

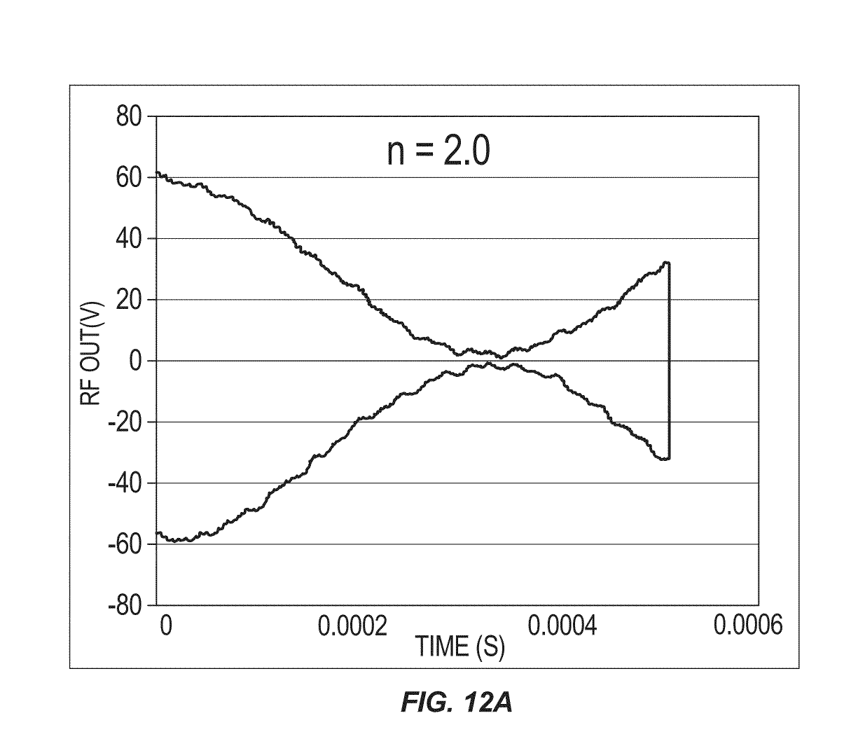

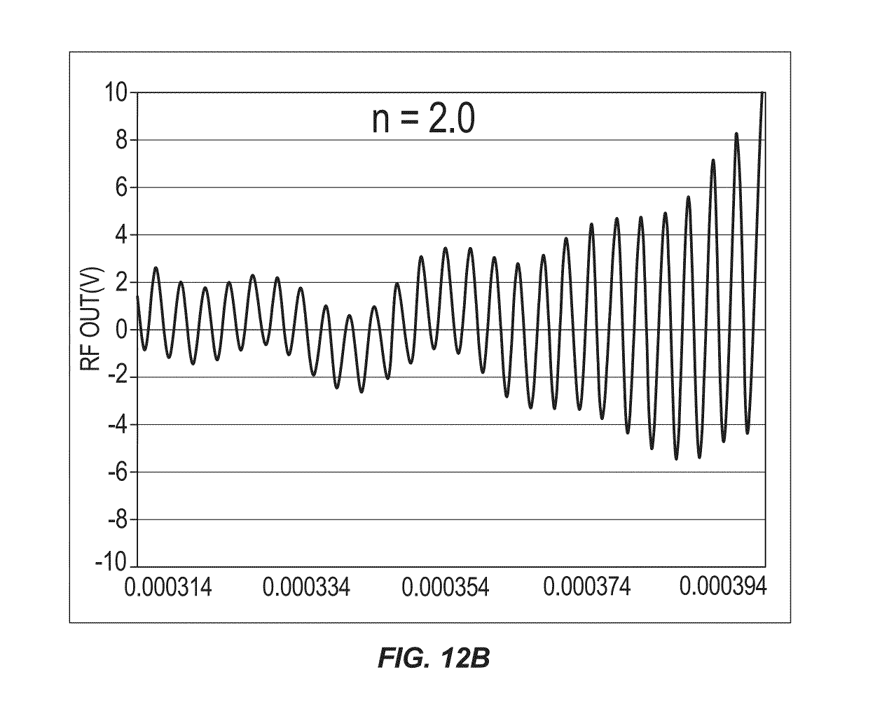

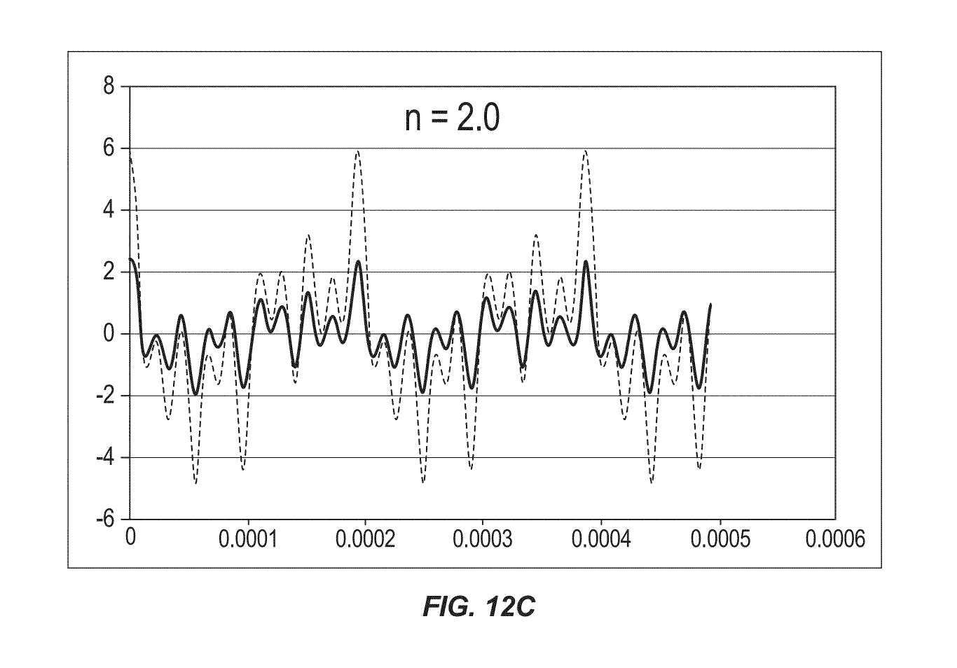

During a noise reduction process using any one of noise reducing systems 602, 802, and 1002, and selecting adaptive control factor “n” to be equal to 2.0, FIG. 12A illustrates a resulting AM broadcast signal 1202 that represents AM broadcast signal 1102 with the reduced add-on noise signal 1106. FIG. 12B illustrates the zoomed section of AM broadcast signal 1102 shown in FIG. 11B after the noise reduction, and FIG. 12C illustrates the reduced version of add-on noise signal 1106.

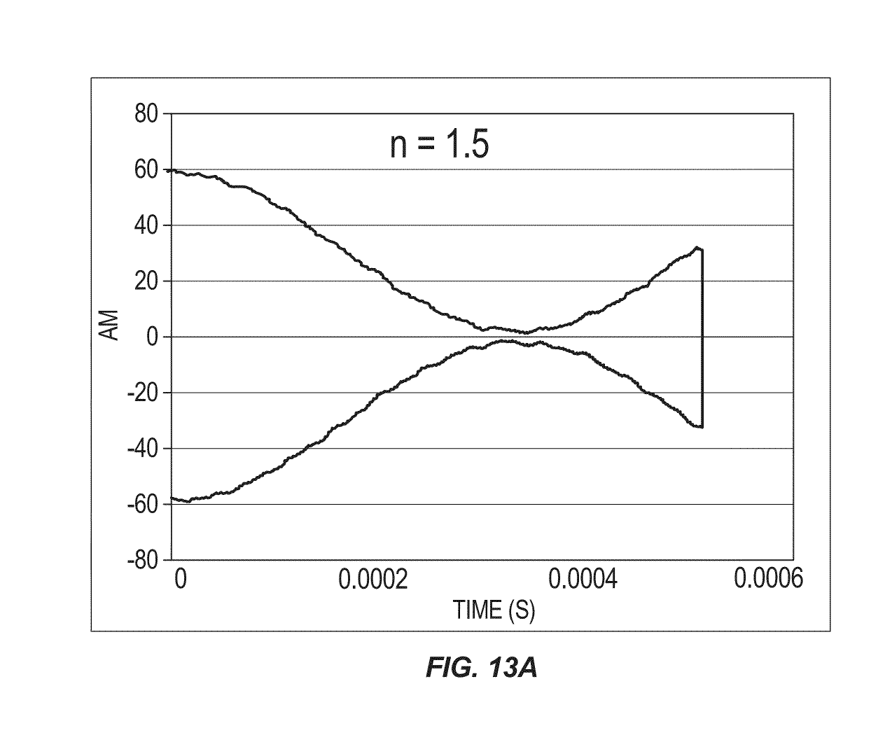

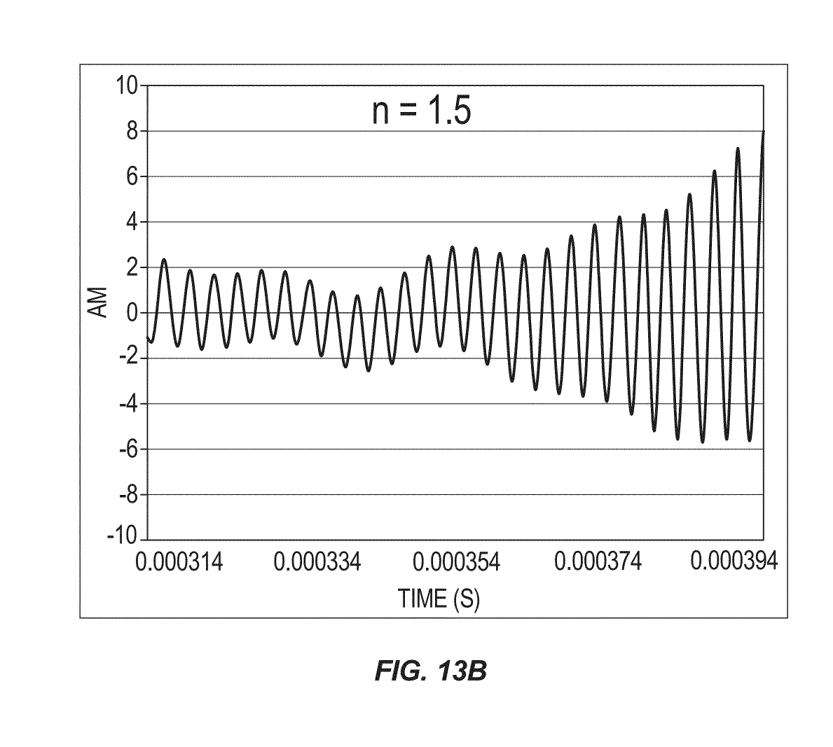

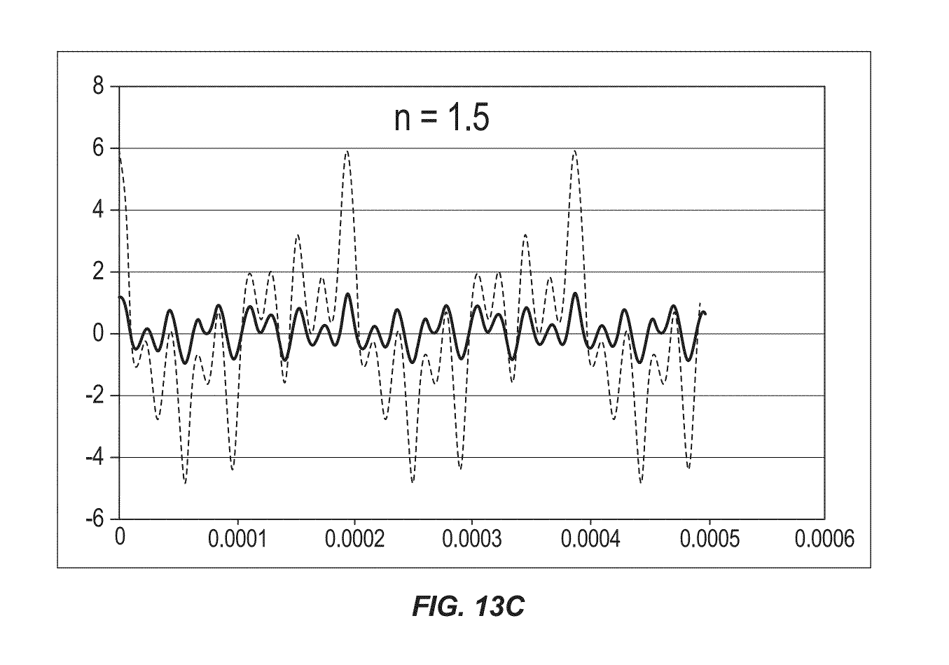

To further reduce add-on noise signal 1106, noise reducing systems 602, 802, and 1002 are configured to adaptively vary the value of adjusting control factor n. As such, based on a continuous analysis of outputted noise-reduced AM signals, adjusting control factor n was selected to be equal to 1.5, which lead to a further reduction of add-on noise signal 1106 as illustrated in a further smoother waveform of AM broadcast signal 1102, and a further reduced amplitude-wise of add-on noise signal 1106, shown in FIGS. 13A and 13C.

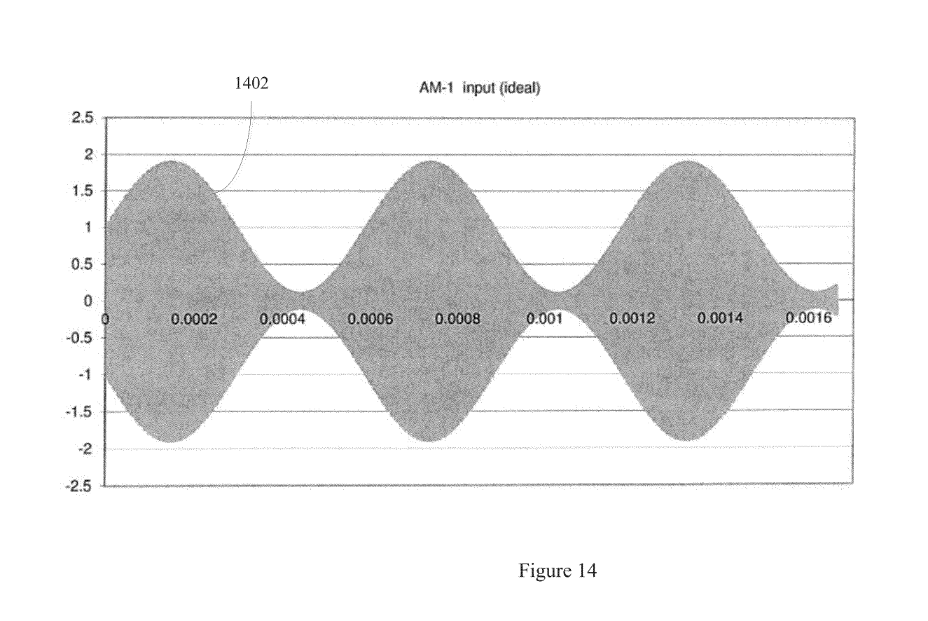

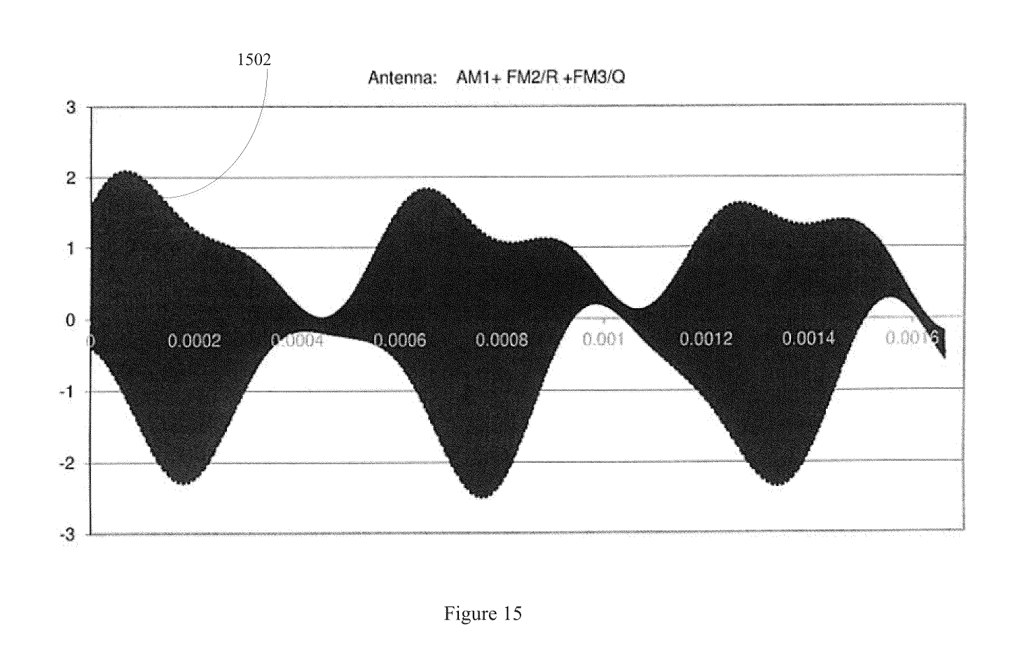

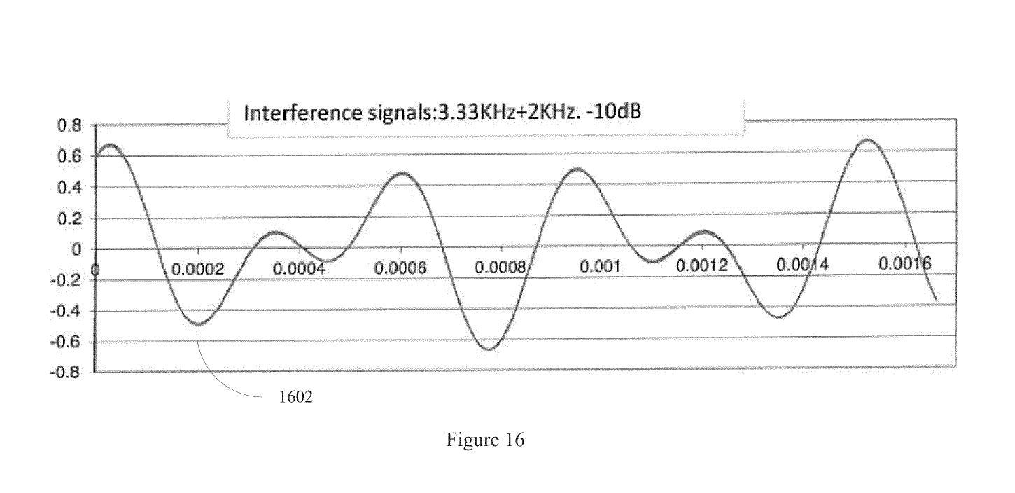

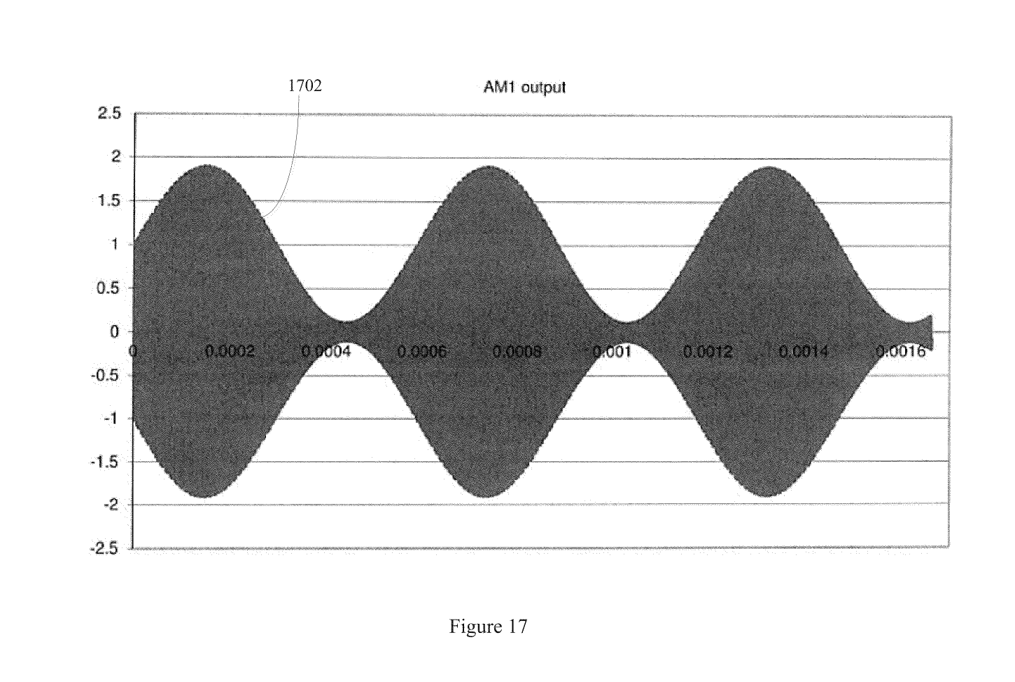

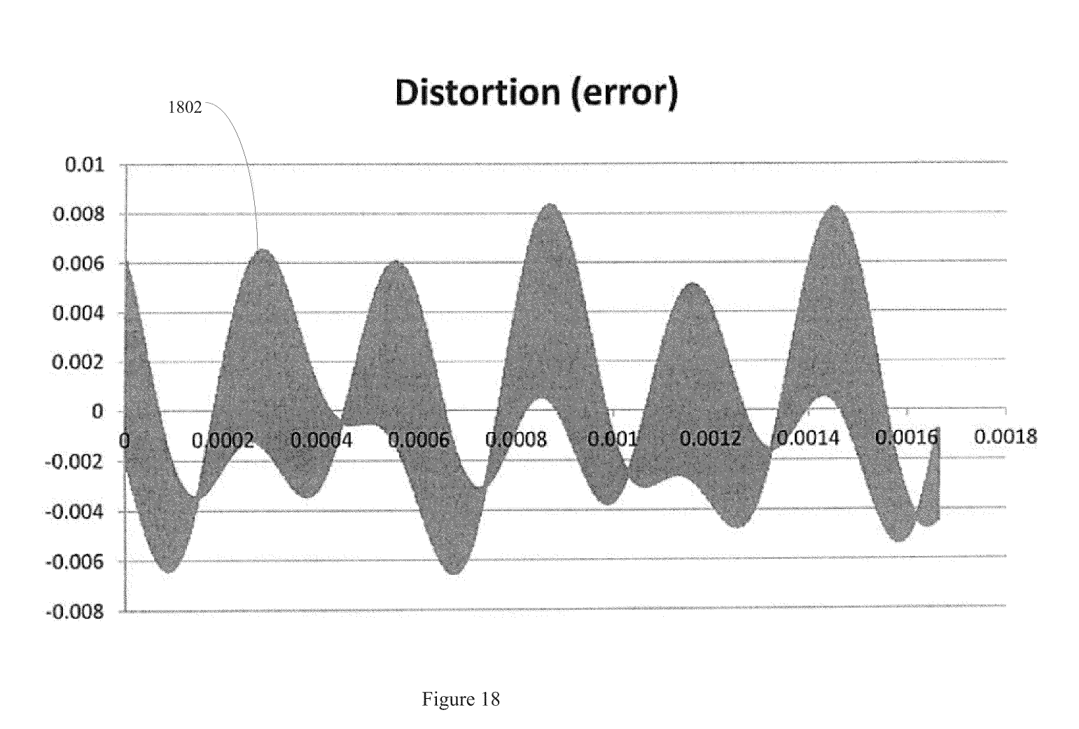

Now referring to FIG. 14, a graph 1400 illustrates an embodiment of an uncorrupted AM broadcast signal 1402 provided with a substantially perfect signal modulation. As an example, AM broadcast signal 1402 has a frequency of 1.7 KHz and is amplitude-modulated by a 300 KHz waveform carrier (not shown). During its broadcast travel, AM broadcast signal 1402 is corrupted by a couple of add-on noise signals. These interfering noise signals are both frequency modulated (FM) signals having frequencies equal to 3.33 KHz and 2.0 KHz, respectively, whose composite signal is illustrated by waveform 1602 of FIG. 16. The corrupted version of AM broadcast signal 1402 is illustrated by waveform 1502 of FIG. 15. By processing the corrupted version of AM broadcast signal 1402 using any one of noise reducing systems 602, 802, and 1002, a noise-reduced signal version of AM broadcast signal 1402 is generated as illustrated by waveform 1702, shown in FIG. 17. The removed distorting component of waveform 1502 is illustrated by waveform 1802 of FIG. 18.

In one embodiment, each of noise reducing systems 602, 802, and 1002 include a processing unit and a memory unit. Each of the processing units can be implemented on a single-chip. For example, various architectures can be used including dedicated or embedded microprocessor (μP), a microcontroller (μC), or any combination thereof. Each of the memory units may be of any type of memory now known or later developed including but not limited to volatile memory (such as RAM), non-volatile memory (such as ROM, flash memory, etc.) or any combination thereof, which may store software that can be accessed and executed by the processing units, for example. Each of the memory units are configured to store instructions that correspond to the processing functions of the above discussed noise reducing systems.

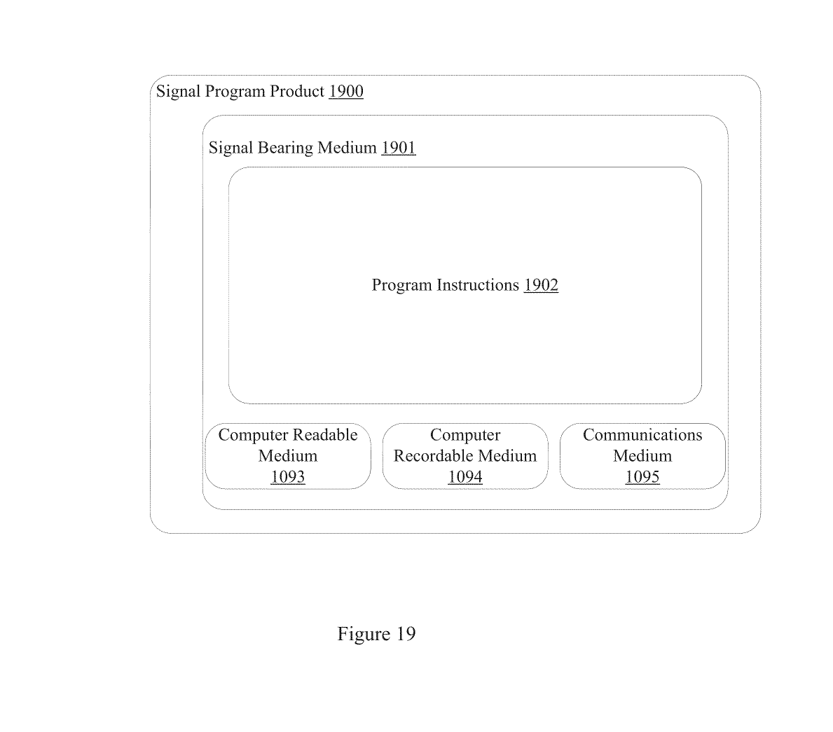

In some embodiments, the disclosed method may be implemented as computer program instructions encoded on a non-transitory computer-readable storage media in a machine-readable format. FIG. 19 is a schematic illustrating a conceptual partial view of an example computer program product 1900 that includes a computer program for executing a computer process on a computing device, arranged according to at least some embodiments presented herein. In one embodiment, the example computer program product 1900 is provided using a signal bearing medium 1901. The signal bearing medium 1301 may include one or more programming instructions 1902 that, when executed by one or more processors may provide functionality or portions of the functionality described above with respect to FIGS. 7 and 9. Thus, for example, referring the embodiments shown in FIGS. 7 and 9, one or more features of blocks 702, 704, 706, 708 and/or 710 and 902, 904, 906, 908, 910 and/or 912, respectively, may be undertaken by one or more instructions associated with the signal bearing medium 1901.

In some examples, the signal bearing medium 1901 may encompass a non-transitory computer-readable medium 1903, such as, but not limited to, a hard disk drive, a Compact Disc (CD), a Digital Video Disk (DVD), a digital tape, memory, etc. In some implementations, the signal bearing medium 1901 may encompass a computer recordable medium 1904, such as, but not limited to, memory, read/write (R/W) CDs, R/W DVDs, etc. In some implementations, the signal bearing medium 1901 may encompass a communications medium 1905, such as, but not limited to, a digital and/or an analog communication medium (e.g., a fiber optic cable, a waveguide, a wired communications link, a wireless communication link, etc.).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular embodiments only, and is not intended to be limiting.

What is claimed is:

1. A computer-implemented method for reducing a noise signal added to an amplitude modulated (AM) broadcast signal while travelling from a broadcasting antenna to a receiving antenna, comprising:
capturing a signal representative of the AM broadcast signal corrupted by the noise signal via the receiving antenna;
inverting the captured signal;
determining a carrying frequency of the AM broadcast signal and delaying the inverted waveform by a fraction of a cycle of the carrying frequency;
generating a difference signal by subtractively combining the captured signal and the delayed inverted signal;
generating an estimate noise signal by reducing an amplitude of the generated difference signal using a noise-reduction control multiplier, wherein the generated estimate noise signal represents an estimate of the corrupting noise signal; and
minimizing the corrupting noise signal component of the captured signal by subtractively combining the captured signal and the generated estimate noise signal.

2. The computer-implemented method of claim 1, wherein a fraction of a cycle is equal to about a half cycle.

3. The computer-implemented method of claim 1, further comprising filtering captured signal prior to the signal inversion.

4. The computer-implemented method of claim 1, further comprising processing the captured signal through a low noise amplifying unit.

5. The computer-implemented method of claim 1, further comprising processing the captured signal through an analog to digital converting unit to generate a digital version of the captured signal prior to the signal inversion.

6. The computer-implemented method of claim 1, wherein the noise-reduction control multiplier is equal to a rational number 1/n with n being a number that is greater than a first value equal to about one (1) and is less than a second value equal to about two (2).

7. A system for reducing a noise signal added to an amplitude modulated (AM) broadcast signal while travelling from a broadcasting antenna to a receiving antenna, comprising:
a receiving unit for capturing a signal representative of the AM broadcast signal corrupted by the noise signal;
a signal inverting unit for inverting the captured signal;
a signal frequency determining unit for determining a carrying frequency of the AM broadcast signal and delaying the inverted waveform by a fraction of a cycle of the carrying frequency;
a first signal differentiating unit for generating a difference signal by subtractively combining the captured signal and the delayed inverted signal;
a signal amplitude reducing unit for reducing an amplitude of the generated difference signal using a noise-reduction control multiplier to generate an estimate noise signal, wherein the generated estimate noise signal represents an estimate of the corrupting noise signal; and
a second signal differentiating unit for minimizing the corrupting noise signal component of the captured signal by subtractively combining the captured signal and the generated estimate noise signal.

8. The system of claim 7, wherein a fraction of a cycle is equal to about a half cycle.

9. The system of claim 7, further comprising a filtering unit for filtering captured signal prior to the signal inversion.

10. The system of claim 1, further comprising a low noise amplifying unit for amplifying a low noise component of the captured signal.

11. The system of claim 1, further comprising an analog to digital converting unit for generating a digital version of the captured signal prior to the signal inversion.

12. The system of claim 1, wherein the noise-reduction control multiplier is equal to a rational number 1/n with n being a number that is greater than a first value equal to about one (1) and is less than a second value equal to about two (2).

13. A non-stationary computer readable storage medium having stored therein instructions executable by a computing element to cause the computing element to perform functions configured to reduce a noise signal added to an amplitude modulated (AM) broadcast signal while travelling from a broadcasting antenna to a receiving antenna, the functions comprising:
capturing a signal representative of the AM broadcast signal corrupted by the noise signal via the receiving antenna;
inverting the captured signal;
determining a carrying frequency of the AM broadcast signal and delaying the inverted waveform by a fraction of a cycle of the carrying frequency;
generating a difference signal by subtractively combining the captured signal and the delayed inverted signal;
generating an estimate noise signal by reducing an amplitude of the generated difference signal using a noise-reduction control multiplier, wherein the generated estimate noise signal represents an estimate of the corrupting noise signal; and
minimizing the corrupting noise signal component of the captured signal by subtractively combining the captured signal and the generated estimate noise signal.

14. The non-stationary computer readable storage medium of claim 13, wherein a fraction of a cycle is equal to about a half cycle.

15. The non-stationary computer readable storage medium of claim 13, further comprising filtering captured signal prior to the signal inversion.

16. The non-stationary computer readable storage medium of claim 13, further comprising processing the captured signal through a low noise amplifying unit.

17. The non-stationary computer readable storage medium of claim 1, further comprising processing the captured signal through an analog to digital converting unit to generate a digital version of the captured signal prior to the signal inversion.

18. A computing system comprising:
at least one memory unit for storing program instructions for reducing a noise signal added to an amplitude modulated (AM) broadcast signal while travelling from a broadcasting antenna to a receiving antenna, and at least one processing unit for executing the program instructions; and
wherein the program instructions comprise:
capturing a signal representative of the AM broadcast signal corrupted by the noise signal via the receiving antenna;
inverting the captured signal;
determining a carrying frequency of the AM broadcast signal and delaying the inverted waveform by a fraction of a cycle of the carrying frequency;
generating a difference signal by subtractively combining the captured signal and the delayed inverted signal;
generating an estimate noise signal by reducing an amplitude of the generated difference signal using a noise-reduction control multiplier, wherein the generated estimate noise signal represents an estimate of the corrupting noise signal; and
minimizing the corrupting noise signal component of the captured signal by subtractively combining the captured signal and the generated estimate noise signal.

19. The computing system of claim 18, wherein a fraction of a cycle is equal to about a half cycle.

20. The computing system of claim 13, further comprising filtering captured signal prior to the signal inversion.
